(19) United States
(12) Patent Application Publication
(10) Pub. No.: US 2016/0212983 A1
(43) Pub. Date: Jul. 28, 2016

(54) Live bait angel and chum bucket syetem

(71) Applicant: Lawrence Boudreau, Hudson, FL (US)

(72) Inventor: Lawrence Boudreau, Hudson, FL (US)

(21) Appl. No.: 14/544,591

(22) Filed: Jan. 26, 2015

(51) Int. Cl. A01K 97/02; A01K 99/00; A01K 97/04

(52) U.S. Cl. CPC A01K 97/02; A01K 97/04; A01K 99/00

(57) ABSTRACT

The Live Bait Angel and Chum Bucket System extends the life of the bait being used for fishing and also releases chum into the water and or releases the smell into the water to attract more fish for a longer period of time. One bucket has holes and fits into the second bucket without holes and has a floating device that holds the bucket or buckets in the water at the same time.

### BACKGROUND OF THE INVENTION

(1) Field of the Invention

The Live Bait Angel and Chum Bucket System is a new concept in using live bait and chum for fishing in fresh water or salt water.

(2) Description of the Art Including Information Disclosed Under 37 CFR 1.97 & 1.98

The art described in the drawings of the design and utility function illustrate the unique ability of the bait angel and chum bucket and is transferring from a provisional patent application filed on Feb. 1, 2014 File No. 61/934,737 and is a continuation to a utility patent application.

### BRIEF SUMMARY OF THE INVENTION

The live bait angel and chum bucket system is a method of using two buckets with a floating device to release chum into the water and to keep larger live bait held in the bucket with holes for a longer lasting bait and fishing experience.

### BRIEF DESCRIPTION OF THE SEVERAL VIEWS OF THE DRAWINGS

There are 6 drawings in total that describe and illustrate the design and function of the live bait angel and chum bucket system.

FIG. 1: is the ¾ elevation view of the system with all of its parts;

FIG. 2: is the front elevation view of the system with all of its parts;

FIG. 3: is the side elevation view of the system with all of its parts;

FIG. 4: is the top view of the bucket with the holes;

FIG. 5: is the bottom view of the bucket with holes;

FIG. 6: is the ¾ exploded elevation of the system with all of its parts separated.

### DETAILED DESCRIPTION OF THE PREFERRED EMBODIMENT

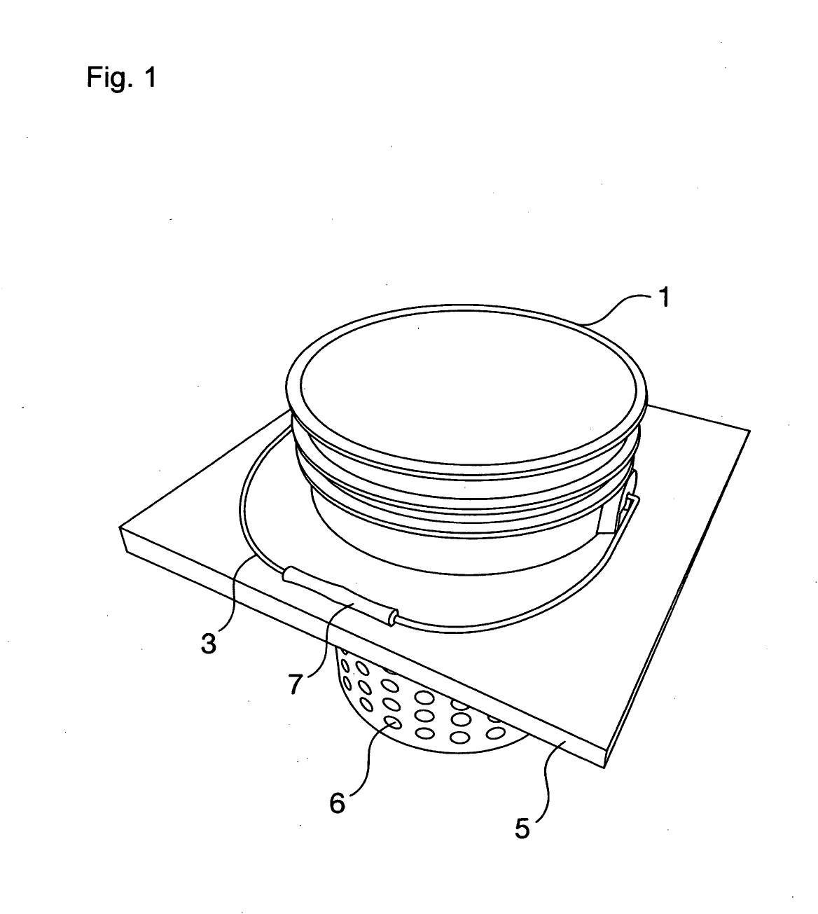

FIG. 1: In this ¾ elevation view illustration showing #1 the bait bucket with the ¼″ holes with #3 the metal handle attached to the bait bucket with #5 the Styrofoam floatation device that holds the bait bucket on top of the water to keep the bait alive and to release the smell or small chum inside the bait bucket to attract more fish with #6 the ¼″ holes in the bottom half of the bait bucket so that the hole is large enough to release chum into the water and small enough to keep the live bait inside the bait bucket until needed with #7 the plastic handle grip for the bait bucket.

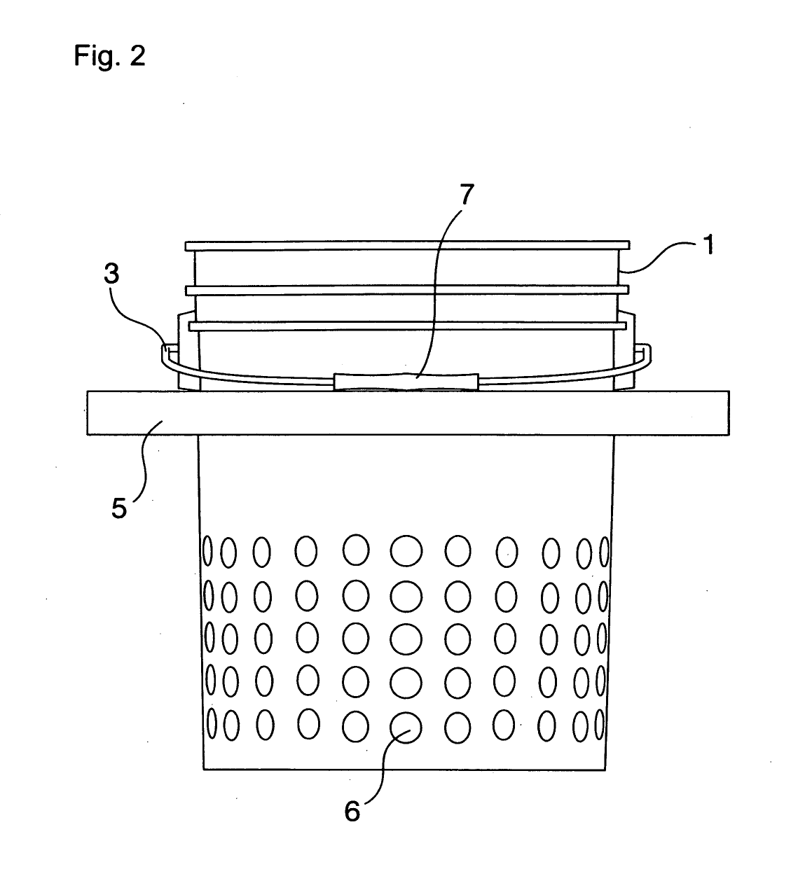

FIG. 2: In front elevation view illustration showing #1 the bait bucket with the ¼″ holes with #3 the metal handle attached to the bait bucket with #5 the Styrofoam floatation device that holds the bait bucket on top of the water to keep the bait alive and to release the smell or small chum inside the bait bucket to attract more fish with #6 the ¼″ holes in the bottom half of the bait bucket so that the hole is large enough to release chum into the water and small enough to keep the live bait inside the bait bucket until needed with #7 the plastic handle grip for the bait bucket.

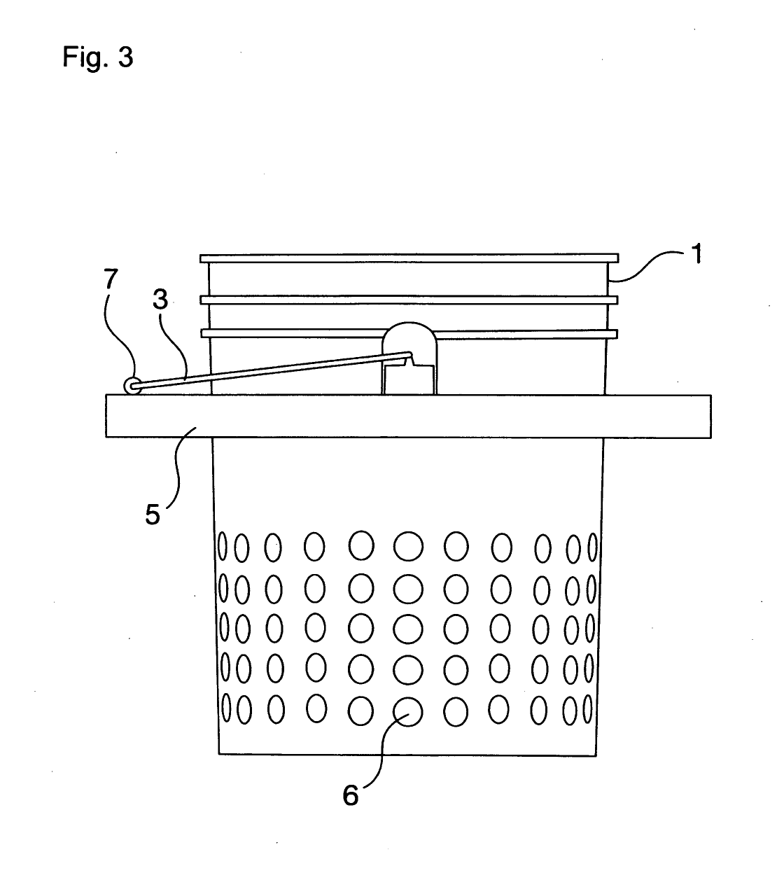

FIG. 3: In this side elevation view illustration showing #1 the bait bucket with the ¼″ holes with #3 the metal handle attached to the bait bucket with #5 the Styrofoam floatation device that holds the bait bucket on top of the water to keep the bait alive and to release the smell or small chum inside the bait bucket to attract more fish with #6 the ¼″ holes in the bottom half of the bait bucket so that the hole is large enough to release chum into the water and small enough to keep the live bait inside the bait bucket until needed with #7 the plastic handle grip for the bait bucket.

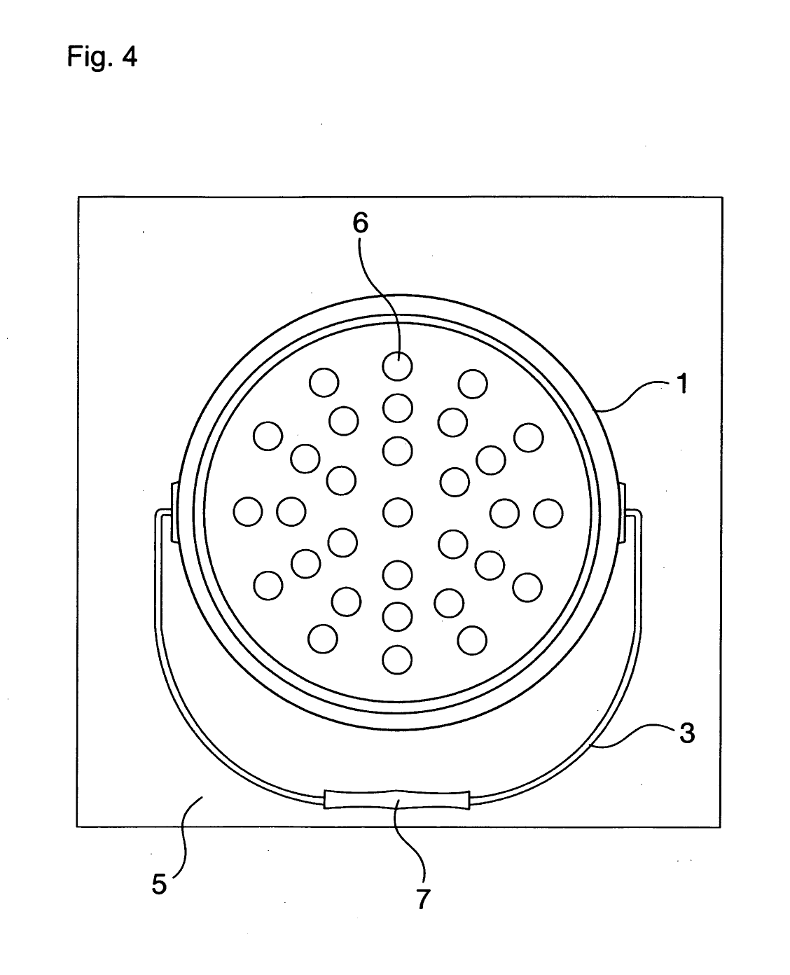

FIG. 4: In this top elevation view illustration showing #1 the bait bucket with the ¼″ holes with #3 the metal handle attached to the bait bucket with #5 the Styrofoam floatation device that holds the bait bucket on top of the water to keep the bait alive and to release the smell or small chum inside the bait bucket to attract more fish with #6 the ¼″ holes in the bottom half of the bait bucket so that the hole is large enough to release chum into the water and small enough to keep the live bait inside the bait bucket until needed with #7 the plastic handle grip for the bait bucket.

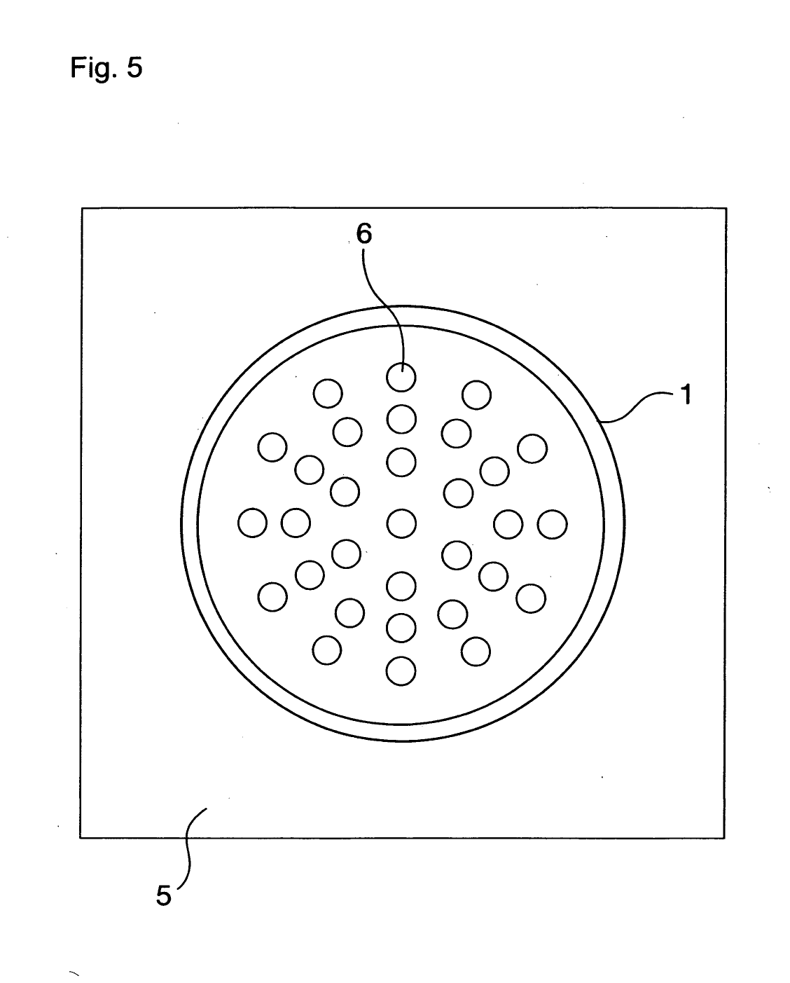

FIG. 5: In this bottom elevation view illustration showing #1 the bait bucket with the ¼″ holes with #5 the Styrofoam floatation device that holds the bait bucket on top of the water to keep the bait alive and to release the smell or small chum inside the bait bucket to attract more fish with #6 the ¼″ holes in the bottom half of the bait bucket so that the hole is large enough to release chum into the water and small enough to keep the live bait inside the bait bucket until needed.

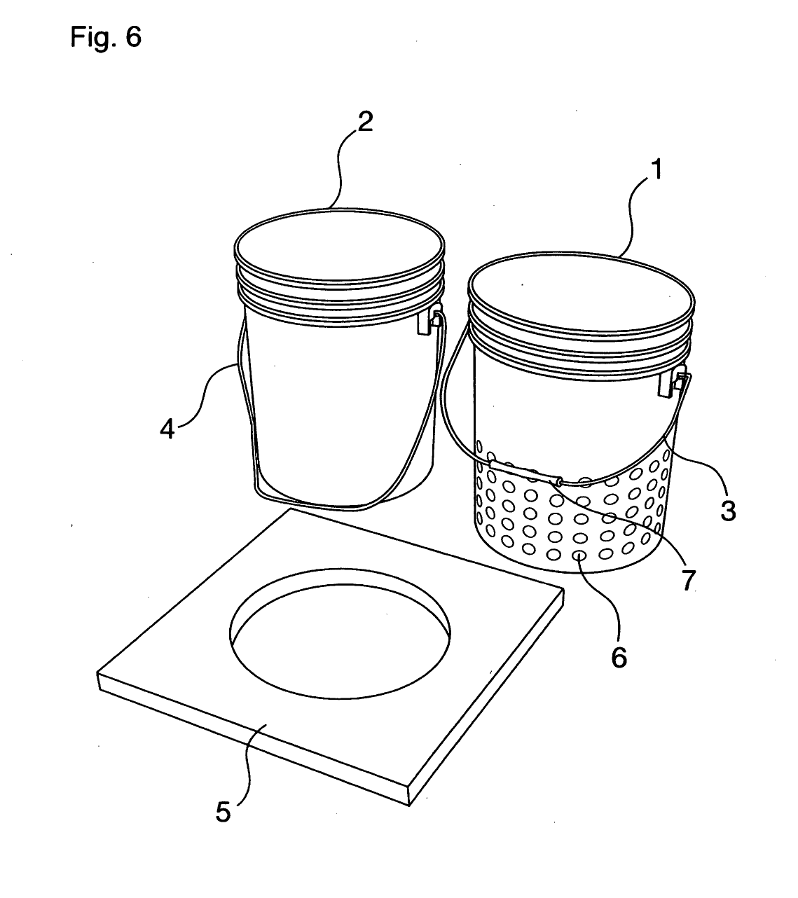

FIG. 6: In illustration showing #1 the bait bucket with the ¼″ holes with #2 the 5 gallon bucket which holds the bait bucket inside to hold water to keep the bait alive prior to placing it into the water with #3 the metal handle attached to the bait bucket with #4 the Rope Handle that is long enough to stretch over the floatation device and lift to separate the bait bucket from the 5 gallon bucket with #5 the Styrofoam floatation device that holds the bait bucket on top of the water to keep the bait alive and to release the smell or small chum inside the bait bucket to attract more fish with #6 the ¼″ holes in the bottom half of the bait bucket so that the hole is large enough to release chum into the water and small enough to keep the live bait inside the bait bucket until needed with #7 the plastic handle grip for the bait bucket.

### DETAILED DESCRIPTION OF THE INVENTION

The Live bait Angel and Chum Bucket System is a live bait bucket with the ¼″ holes and the 5 gallon bucket which holds the bait bucket inside to hold water to keep the bait alive prior to placing it into the water with the metal handle attached to the bait bucket with the Rope Handle that is long enough to stretch over the floatation device and lift to separate the bait bucket from the 5 gallon bucket with the Styrofoam floatation device that holds the bait bucket on top of the water to keep the bait alive and to release the smell or small chum inside the bait bucket to attract more fish with the ¼″ holes in the bottom half of the bait bucket so that the hole is large enough to release chum into the water and small enough to keep the live bait inside the bait bucket until needed with the plastic handle grip for the bait bucket. Holes are evenly spaced, ¼″ holes, in 5 rows (standard) with more rows possible on the circumference of the interior bucket with the same diameter holes evenly spaced on the bottom of the interior bucket. The ¼″ holes are imperative to the function of the bucket to allow live bait to stay in place and chum to be released into the water. Handle for interior bucket is a standard metal handle and it may also be cloth handle like exterior bucket has. Invasive species laws for fresh water can cause you to lose bait while transferring bait at the dock. With conventional bait buckets your live bait can undergo a stress factor when transferring from pond water to tap water to portage and from one lake to another. The bait angel bucket allows you to keep bait in the interior float bucket while emptying pond water and replacing it with the tap water the interior bucket is kept in the pond while refilling the exterior bucket with the tap water when lifted out of pond all water drains then simply reinsert the interior bucket into the tap water filled exterior bucket with 0 2 tabs or aerator to minimize the stress to your bait. Perforations encompass the interior bucket side and bottom to allow aerated water to flow freely to the bait and allow the water to quickly drain when removed from the exterior bucket which prolongs the life of the live bat and slows the release of chum when used as a chum bucket. With the floatation device in place it is made available in the bottom of the exterior bucket to place oxygen tablets to prolong bait life while in transit. When placed alone in saltwater or fresh water it allows the bait acclimatize to the waters you will be fishing in or said waters can be placed in the bottom of the bucket for short periods of time and the more the water is changed the longer the bait will live. Being made of plastic makes this device durable enough to keep predators away from the bait while being submerged. When the bait angel bucket is being used as a chum bucket it helps to maintain a measured release of chum into the waters allowing a scent trail while minimizing chunk foods in the water so fish will go after your line bait rather than gorging themselves on the free chum floating in the water. The exterior bucket holds excessive blood and small particulate matter that can be refreshed by reinserting interior bucket into the exterior bucket then reintroducing interior bucket into your fishing waters. When trolling with the Bait Angel Bucket the floatation device can be removed at any time. The bucket can be attached to a boat for instance and pulled through the water for an even better chum release action.

What is claimed is:

1. A live bait angel and chum bucket system with parts comprising of:
a. a bait bucket with the ¼″ holes;
b. a 5 gallon bucket which holds the bait bucket inside to hold water to keep the bait alive prior to placing it into the water;
c. a metal handle attached to the bait bucket;
d. a rope handle attached to the 5 gallon bucket that is long enough to stretch over the floatation device and lift to separate the bait bucket from the 5 gallon bucket;
e. a detachable Styrofoam floatation device that holds the bait bucket on top of the water to keep the bait alive and to release the smell or small chum inside the bait bucket to attract more fish;
f. a large number of perforated ¼″ holes in the bottom half side and bottom of the bait bucket so that the hole is large enough to release chum into the water and small enough to keep the live bait inside the bait bucket until needed;
g. a plastic handle grip for the bait bucket.
